(19) United States
(12) Patent Application Publication
(10) Pub. No.: US 2006/0204946 A1
(43) Pub. Date: Sep. 14, 2006

(54) System to teach emotional competence

(76) Inventor: John L. Avella, New York, NY (US)

Correspondence Address: John L. Avella, Apt. 3H, 45 Park Terrace West, New York, NY, 10034, US

(21) Appl. No.: 11/076,302

(22) Filed: Mar. 9, 2005

(51) Int. Cl. G09B 7/00

(52) U.S. Cl. 434/323

(57) ABSTRACT

A system to teach emotional competence which includes the steps of orienting management and participants in a protocol so that they may complete a Bar-On EQI. The results of the Bar-On EQI are evaluated and communicated to the participants requesting the participants to develop a learning contract. The learning contracts direct the participants to specific workshops in which they develop goals and evaluate results of participation in the workshops in a group forum.

### I. FIELD OF THE INVENTION

This invention relates to a system for teaching and more specifically a system to teach emotional competence. The continuing debate as to whether emotional IQ or IQ is a predictor of workplace performance is well known in the prior art. Questions relating to the efficacy of emotional IQ or EI to predict success more strongly than conventional IQ continue in the marketplace. As Daniel Goleman has set out in his book The Emotionally Intelligent Workplace “In one sense, this question is purely academic: in life, cognitive abilities and emotional intelligence always interplay. But in another sense, it has practical implications for significant workplace decisions.” In his work, Goleman goes on to state that the Claudio Fernandez-Araoz offers qualitative data suggesting that basing the selection of high-level executives solely on their academic intelligence and business expertise and ignoring their emotional intelligence often leads to poor choices that can be disastrous for an organization. There is an evolving basis in the marketplace which sustains the proposition that one can expect both EI and IQ to make separate and discrete contributions to performance. For example, early studies of the correlation between IQ and EI show a range of from 0 to 0.36 depending on the measures used. According to Goleman in his book, John Mayer, using his own EI measure, reports a zero correlation with fluid intelligence and a 0.36 correlation with verbal IQ.

One of the pioneers in the emotional IQ arena, Reuven Bar-On, using his own measure, has found correlations ranging from 0.06 to 0.12-positive but not significant. Although the EI concept has been articulated relatively recently, there has not been time to conduct a longitudinal study designed to assess the predictive power of EI relative to IQ in distinguishing workplace performance over the course of a career. In his book, Goleman states that it is his belief that if such a study were done, IQ would be a much stronger predictor than EI of which jobs and professions people can enter. According to Goleman, IQ stands as a proxy for the cognitive complexity a person can process and should be capable of predicting what technical expertise that person can master. Technical expertise represents the major set of threshold competencies that determine whether a person can obtain and maintain a job in a given field while IQ plays a sorting function in determining what jobs people can obtain. Consequently, having enough cognitive intelligence to maintain a given job does not in and of itself predict whether one will be an outstanding performer or rise to management or leadership position in this respective field. It is known that in occupations of varying kinds, emotional competencies are twice as prevalent among distinguishing competencies as were technical skills and purely cognitive abilities combined. Generally speaking, the higher the position in an organization, the more dramatic EI factored as a predictive mechanism. In management positions, 85% of their competencies were in the EI domain. The value of EI competencies reflected in these competency models relative to technical and cognitive abilities are highly consequential. These models are considered to be predictors of guiding decisions on initiating employment, who is to be moved ahead, promoted or fast-tracked, and where management chooses to concentrate their efforts in building leadership in many of the largest organizations throughout the world.

In many cases, it is found that EI strongly dominates intellect alone since in the classes of participants evaluated, high entry hurdles for IQ and technical competence were a requirement. Particularly at the higher levels of organization, these so-called technical or cognitive competencies are considered to be threshold skills which are essential for entry into fields like engineering, law or the executive management of an organization. Since it is accepted that most everyone in a given field has these requisite threshold skills, these basic abilities are less significant in distinguishing competencies as well as capabilities that set apart outstanding performers from those that are average.

IQ is found mainly to predict a given profession for an individual and a position in that profession that one can obtain and maintain. For example, it is known that certain mental acumen is required to pass the bar exam or the MCATs and, furthermore, in order to establish that the requisite skills are present, participants are expected to demonstrate mastery of require course work of technical subjects to enter a profession such as law, engineering or senior management. Generally speaking, it has been shown that IQ in the range of 110 to 120 place participants in a pool of people in a given profession where they are competing with participants who are at the high end of the bell curve for their respective IQ. This lends great support to the proposition that although IQ is a strong predictor of success among the general population, it diminishes in predicting outstanding performance since the individuals being compared are in a narrow class of people applying for a given job in an organization at higher levels. Goleman states “In contrast, there is less systematic selection pressure for emotional intelligence along the way to entering the ranks of such professions. Of course some minimal level of EI is needed to be successful in school and to enter a profession, but because there is no specific EI hurdle one must clear to enter a profession, there is a much wider range of EI abilities among those one competes with in one's field. For that reason, once people are in a given job role, or profession, EI emerges as a more powerful predictor of who succeeds and who does not—for instance, who is promoted to the upper echelons of management and who is passed over.”

Goleman comes to the conclusion that IQ will be a more powerful predictor than EI in determining the success of individuals' careers in studies of large populations since EI, unlike IQ, tends to sort out people before they embark on a career determining which fields of professions they may enter. Consequently, EI should prove a much more powerful predictive system of success than IQ when such studies within a profession demonstrate whether the participants succeed, plateau or fail in their endeavors.

Few studies have been performed longitudinally in attempting to compare the contribution of cognitive competencies and EI competencies as gauged by promotions. One such study was performed by Dulewicz and Higgs in 1998 who considered data from a seven-year study of the career progress of fifty-eight general managers in the United Kingdom and Ireland. They assessed three domains, one of which was EQ, another of which was IQ and a third which they designated as managerial competence, or MQ, that they ascertained contributed to the on-job performance of these managers. In these assessments, emotional IQ was said to comprise the manager's ability to demonstrate resilience, influence, assertiveness, integrity and leadership. In addition, IQ was not measured by employing conventional IQ tests, but by measuring such competencies as ability to analyze, judgment, planning skills, creativity and, to some extent, risk taking. The MQ employed included skills relating to supervision, oral communication, business sense, self-management, initiative and independence. As a result, emotional IQ was found to be a significant predictive tool by Dulewicz and Higgs accounting for 36 percent of the advancement which was realized by these participants, whereas IQ accounted for approximately 27 percent and MQ 16 percent. Emotional IQ or emotional competencies as contrasted to cognitive skills have also been demonstrated in drawing on models from forty companies which revealed that strengths and purely cognitive skills were 27 percent more frequent in their stellar performers than in the average performers. In these same stellar performers, significantly dramatic strengths were demonstrated in emotional IQ by 53 percent. In a study performed in 1982 by Boyatzis of 2,000 supervisors, middle managers and executives at twelve organizations, it was found that all but two of the sixteen capabilities setting apart the stellar performer from the average performer were emotional competencies. In an analysis of 286 organizations worldwide by Spencer and Spencer in 1993 it was indicated that eighteen of the twenty-one competencies in their model for distinguishing the stellar performer from the average performer were based on EI.

Essentially to define the roots of the field, Emmerling and Goleman note that there have been three general approaches to EI represented by Reuven Bar-On, Daniel Goleman and Jack Mayer-Peter Salovey. Reuven Bar-On's approach appears to be directed to subjective well-being and related to non-intellective aspects of performance. Goleman's approach is predicated pursuant to his studies of David McClelland, one of the most influential psychologists in the area of competencies. Jack Mayer, who was trained in both clinical and experimental psychology, having worked in the areas of human intelligence as well as cognition and affect (how emotions and thinking interact), had similar interest to Peter Salovey which resulted in conducting research, developing assessments and consulting to organizations and individuals to develop their similar interests in cognition and affect and its various applications, especially to health psychology. In his conclusions, David R. Caruso, Ph.D, in the work Comment on R. J. Emmerling and D. Goleman, Emotional Intelligence: Issues and Common Misunderstandings, he sets out that huge corporations have been brought to their knees because their boards were filled with insiders or their books audited by companies with a vested interest in selling more lucrative consulting services. These problems were ignored and negative results were discarded so that if as a body of science and practice we suppress critical comments, surround ourselves with insiders and fail to ask the tough questions, we may have a happier feel but a less effective one. Tough questions must be asked, conducting research, providing constructive criticism and engaging in passionate debate with each other. Collectively we need to remain open to the wisdom of our own emotions and consider that Emotional Intelligence: Issues and Common Misunderstandings is an excellent contribution to productively defining the issues in this field. In his article, Steve Hein's critique of Emmerling/Goleman October 2003 article entitled Emotional Intelligence: Issues and Common Misunderstandings raises and airs questions that have arisen with the growing interest in emotional intelligence. Hein further elucidates on the problem of multiple theories of emotional intelligence including the Bar-On theory in 2000; the Goleman theories in 1995 and 1998, and Mayer and Salovey in 1997. As Hein concludes in his comments, the progress of the emotional intelligence paradigm has been impressive but much remains to be discovered. According to Hein, there are too many questions, not enough answers and not enough good answers.

### II. OBJECTS OF THE INVENTION

Thus there is seen to be a continuing dramatic need for a system to teach emotional competence, devoid of the above noted deficiencies.

Further, there is a demonstrated need to employ emotional intelligence in a predictive system to assess success in various endeavors.

Further objects of this invention is to orient management and participants in order to evaluate a Bar-On EQI.

### III. SUMMARY OF THE INVENTION

These and other objects of the instant invention are accomplished generally speaking by providing a system to teach emotional competence which comprises the steps of orienting management and participants in a protocol so that they may complete a Bar-On EQI; evaluating results of the Bar-On EQI; communicating the results to the participants; requesting the participants to develop a learning contract; directing participants to specific workshops indicated by the learning contracts; developing goals in these workshops; and evaluating application of knowledge learned in training process as applied to the job.

Any suitable system may be employed to orient management and participants re: protocol to be taught in order to have them complete the Bar-On EQI, there are generally speaking two parts to this process. The first relating to orienting the managers and the participants to the process in order to gain understanding of the process and enable them to plan how to help the participants employ emotional competency on the job; and secondly orienting the participants so that they can understand the process and the guidelines for taking the Bar-On EQI. Typically, in orienting managers and participants, two paths may be followed, either one relating to orienting the participants to the training process or in choosing not to do so. Participating organizations may choose to orient the managers of the participants but not allow them to develop any plan on how they will assist the participants to utilize the new skills on the job. In addition to orienting the participants in a workshop, memos may be suitably drafted to inform the participants in order to explain the process while they are attending the meeting or the participating organizations may choose to provide no information prior to the meeting. As to the participants' orientation, they may either receive a memo relating to the process or their immediate supervisor may inform them of the process or, in the alternative, they may be asked to take the Bar-On EQI without any preparation at all.

Optimally, the participants should understand the process and the guidelines for the assessment and be informed of the confidentiality of the results. Further, the results should not be shared with third parties without the appropriate permission obtained. This confidentiality will insure and motivate the participants to be very candid in their responses to the assessment.

Any suitable method may be employed to evaluate the results of the Bar-On EQI. Typically, the participants take the Bar-On EQI by either employing paper and pencil or on a computer. The results are then sent back to a facilitator who provides the participants with feedback. The facilitators are certified by MHS (the company that owns the rights to the Bar-On) employing a three day training process and a certification test. The results are evaluated by the facilitator based on the style and protocol employed to evaluate these results. Although most facilitators are trained to evaluate the assessments in an elementary fashion, optimally facilitators should employ their experience and education to transcend the MHS criteria. This will require that the facilitators become knowledgeable of the many nuances that are included in the Bar-On and fully understand them so that their evaluations will not be performed on an elementary basis.

Any suitable method may be used to communicate the results to the participants. Optimally, a specific protocol may be followed when transmitting feedback regarding the assessment results. It is preferred that this feedback be done on a face-to-face basis in an environment where the possibility of interruptions is eliminated. The results are prepared in a single paper form with no copies and transmitted to the participants. In other cases, facilitators have sent the results to participants with an explanation of how to apply and understand the results. In still other cases, participants have been sent the results and then interviewed on the telephone. In some cases facilitators have shared assessment results with the participant's supervisor without the participant's permission.

Any suitable method may be employed to request the participants to develop a learning contract. Optimally the participants should be allowed to develop their own learning contract with assistance from the facilitator. The assessment results give some direction as to what the learning contract should comprise, although most participating organizations emphasize application of the new skills to the job alone and it is preferred that an emphasis be given to a methodology for applying the new skills in the participant's personal life. A learning contract is developed from the assessment results and the matrix of learning activities that are available for the participant is outlined. Typically, third parties are not involved in the participant's selection of their learning activities and in most cases participating organizations require that everyone experience all the training. Optimally an individualized process which engages the participants in the learning process and motivates them to learn should be employed. Although typically some facilitators do not use learning contracts and participating companies do not employ learning contracts or develop them or used by the participants, it is highly recommended that the learning contract be employed and developed.

Any suitable method for directing participants to specific workshops and self-directed learning activities indicated by the learning contracts may be employed. In collaboration with the facilitator, typically the participant will choose specific workshops and self-directed learning activities that will match his or her development requirements. These development requirements are identified by the Bar-On assessment and contained in the learning contract. Typical workshops include: empathy, listening and empathic listening, stress management, impulse control, assertiveness and connecting to the customer. The self-directed learning activities typically include: emotional self-awareness, self-actualization, flexibility and problem solving. Optimally, the participants should have a choice of the workshops or other learning activities and the participating companies should structure their training to include a choice of learning activities for the participants. Optimally, there should be both workshops and self-directed learning activities employed. In order to eliminate participant disinterest and frustration and to conserve money, the participants, not the supervisors, should decide which workshops to attend. This is especially true with regard to customer service training where the real problem may be organizational, supervisory or a cultural problem which does not require that all the front-line staff be trained without regard to their personal requirements.

Any suitable method to develop goals in said workshops may be employed. Typically, most participating organizations educate their participants but do not require any commitment or goal setting in order to modify their behavior. Optimally, the value of the skills should be emphasized in the participants conducting their personal lives. Additionally, goals should be set concomitantly related to a reward system to motivate the participants to accomplish their respective goals. Preferably, the participants and their supervisors should share these goals so that they can work together to encourage and support the participant in achieving the goals.

Any suitable method to evaluate results of the participants in workshops in a group forum may be employed. Typically, the participants assemble in a group with a facilitator to discuss their progress or obstacles in using the newly acquired skills on their jobs. This transfer of learning process occurs when the participants discuss and share ways to surmount obstacles to the implementation of the new learning process. Optimally, the participating organizations must be informed of any apparent obstacles to transfer of learning within their culture and be expected to remove them so that the process may be properly implemented.

While the present invention has been particularly described with respect to a preferred sequence of process steps in the system of the instant invention, it will be understood that the invention is not limited to the process steps or the sequence as described in the specification. On the contrary, it is intended to cover all alternatives, modifications, and equivalents as may be included within the spirit and scope of the invention defined by the appended claims.

In addition, although this application is discussed in terms of the Bar-On approach, other approaches recited above may be employed alone or in combination with the Bar-On EQI to obtain improved results in the system of the instant invention. In particular, the scope of the invention is intended to teach emotional competence comprising: (a) orienting management and participants in a protocol to be taught for the completion of a Bar-On EQI; (b) evaluating results of the Bar-On EQI; (c) communicating said results to participants; (d) requesting participants to develop a learning contract; (e) directing participants to specific workshops indicated by said learning contracts; (e) developing goals in said workshops; and (g) evaluating results of participation in workshops in a group forum.

What is claimed is:

1. A system to teach emotional competence, comprising:
(a) orienting management and participants re protocol to be taught in order to have them complete a Bar-On EQI;
(b) evaluating results of the Bar-On EQI;
(c) communicating said results to participants;
(d) requesting participants to develop a learning contract;
(e) directing participants to specific workshops indicated by said learning contracts;
(f) developing goals in said workshops, and;
(g) evaluating results of participation in workshops in a group forum.
